(19) United States
(12) Patent Application Publication
(10) Pub. No.: US 2013/0331013 A1
(43) Pub. Date: Dec. 12, 2013

(54) OSCILLATING IMPACT GRINDING BLADE

(71) Applicants: Wyatt W. Neal, JR., Cottrellville, MI (US); Ralph Girardin, Cottrellville, MI (US); Bryan Pedersen, Cottrellville, MI (US)

(72) Inventors: Wyatt W. Neal, JR., Cottrellville, MI (US); Ralph Girardin, Cottrellville, MI (US); Bryan Pedersen, Cottrellville, MI (US)

(21) Appl. No.: 13/490,895

(22) Filed: Jun. 7, 2012

(51) Int. Cl. B28D 1/12; B24D 18/00

(52) U.S. Cl. 451/461; 76/112

(57) ABSTRACT

An oscillating blade for use with an oscillating tool comprises a base having a predetermined shape and thickness. The oscillating blade also comprises a cutting edge located on a predetermined portion of the circumferential edge of the base. An abrasive coating layer encapsulates the cutting edge and a predetermined wave form is incorporated into the cutting edge. This may allow for the oscillating blade to more efficiently and quickly remove mortar or grout from in between joints of tile, brick, or the like.

### BACKGROUND OF THE INVENTION

1. Field of the Invention

The present invention generally relates to an oscillating impact grinding blade, and more particularly, relates to an oscillating blade for use in an oscillating power tool for removal of masonry or joint masonry fillers.

2. Description of Related Art

Abrasive grit tool structures have been known for numerous years. Generally, the abrasive grit tool structures include devices such as grinding wheels, hand tools, and the like which generally have an outer grit particle surface which is used to remove portions of a work piece for shaping and/or finishing a work piece. In many prior art structures, abrasive grits have been attached to power tool accessory or hand tool surfaces by placing a single layer of grit particles on a tool form and then binding the grits to the tool by using a brazing metal or by an electro plating coating which grips the grit particles. Generally, in the prior art, the removal of grout and/or mortar has been done with a simple impact tool such as a hammer and chisel or hand scraper. However, recently in the prior art, the removal of tile grout has been commonly done with abrasive blades offered as accessories for a popular style of tools known as an oscillating multi-tool or oscillating tool. Furthermore, the oscillating grinding tools have also been known for performing common maintenance tasks in residential and commercial buildings, such as the removal of damaged tile and adjacent tile joint masonry filler, i.e., grout, or removal of damaged brick and block masonry filler, i.e., mortar from between blocks or bricks. These prior art oscillating tools generally are power tools based on the design of medical cast or cast cutters, which uses an often circular or semi-circular blade that oscillates about a single axis, wherein the oscillation occurs over a range of typically only several degrees. These oscillating tools generally are very popular in the prior art because of operator safety, ease of control and versatility of use because of numerous available accessories to do a wide range of contractor or do-it-yourself jobs. Generally, in the prior art, oscillating tools for removing tile grout are fitted with thin circular blades typically made of a sheet metal and armed with abrasive grains of metal bonded tungsten carbide or diamond grit.

There have been some problems in the prior art with the removal of masonry filler or grout while using an oscillating blade. Generally, when viewed at the interface between the abrasive grit and the work this process is much more like demolishing concrete with an impact device, such as a jackhammer. Hence, the material does not curl off in chips due to machining forces, but is removed by crushing the brittle cementitious bond that holds the aggregate together, returning the material to a condition much like it was originally in before the blend of cement and aggregate was mixed with water and allowed to cure. Therefore, the overall design of the oscillating multi-tool makes it very versatile and offers many benefits, however, there have been problems with the material removal rate of oscillating multi tools. It is generally substantially lower than that of a sawing and/or grinding tool that has a rapidly rotating spindle, removing grout or mortar. Generally, this is due to the surface speed of the multi tool blade oscillating at a fraction of the surface speed of common rotating power tools. Hence, a multi-tool abrasive blade with its relatively low peripheral speed only has the individual grits on the abrasive blade hammering away at the masonry or grout filler at a relatively low contact speed and thus are not able to clear away the material very quickly. Furthermore, the prior art also has a problem with the relatively thin kerf of the oscillating blade, because it does not allow for the presentation of sufficient contact width of multiple grits to work at any one time, and hence, the tool has to be either wiggled or run several times through the same joint when it is necessary to clear out a joint wider than the width of the blade. Therefore, a problem may exist in the prior art that without wiggling or sequential laterally offset passes, the oscillating blades for masonry and/or grout removal limits the width of the swath of material removed to just slightly more than the sum of the blank or base member metal thickness and displacement of the layer of abrasive coating.

Hence, there is a need in the prior art for an oscillating blade that overcomes the limitations described above by greatly speeding up the process of removing masonry filler in thin or wide joints. There also is a need in the art for an improved oscillating impact grinding blade that is capable of removing a wider swath of grout or mortar with a single pass of the tool. Furthermore, there is a need in the art for an oscillating impact grinding blade that uses a predetermined wave form pattern on the cutting edge thereof in order to lengthen the cutting edge of the oscillating blade. There also is a need in the art for an improved oscillating impact grinding blade that reduces the time needed to remove grout or mortar and the expense of replacing blades at more frequent intervals.

### SUMMARY OF THE INVENTION

One object of the present invention may be to provide an improved impact oscillating blade for use in an oscillating tool.

Another object of the present invention may be to provide an improved impact oscillating blade that has abrasive grit materials arranged on a cutting edge thereof.

Yet a further object of the present invention may be to provide an oscillating impact blade having a cutting edge with a predetermined wave form arranged thereon.

Still a further object of the present invention may be to provide an oscillating impact blade having a plurality of abrasive grits attached to a wave form edge.

Still another object of the present invention may be to provide an oscillating impact grinding blade that has a cutting edge that has a shape that appears to be that of a scalloped shell when viewed on edge.

Still another object of the present invention may be to provide an oscillating impact grinding blade that may be made into several unique shapes and capable of being connected to several different oscillating impact tools.

To achieve the foregoing objects and advantages, an oscillating blade for use with an oscillating tool is disclosed. The oscillating blade comprises a base member having a predetermined shape and thickness. The oscillating blade also comprises a cutting edge located on a predetermined portion of the circumferential edge of the base wherein an abrasive coating layer encapsulates the cutting edge of the base. The oscillating blade also comprises a predetermined wave form incorporated into the cutting edge in any known alternating wave shape, such as but not limited to, a sine-wave, a “V” shaped wave, a “U” shaped wave, a square wave, a zigzag wave, or any other known axial pattern capable of being formed into the cutting edge of the base of the oscillating blade. The oscillating blade of the present invention may offer quicker removal of masonry joint filler, such as grout or mortar, etc., via an increase in the length of the cutting edge by use of the wave form pattern thereon. Furthermore, the removal may be quicker and more efficient because the abrasive grits encapsulate the entire wave form cutting edge.

One advantage of the present invention may be that it provides an improved oscillating impact grinding blade for use with an oscillating tool.

Still another advantage of the present invention may be that it provides an improved oscillating impact grinding blade for use in removing masonry joint fillers, such as grout and mortar.

Still another advantage of the present invention may be that it provide an oscillating impact grinding blade that has a wave form pattern arranged or formed onto the outer peripheral cutting edge of the blade.

Yet another advantage of the present invention may be that it provides for an oscillating impact grinding blade that has an abrasive coating attached to the wave form cutting edge to increase the removal rate of masonry joint filler.

Still another advantage of the present invention may be that it provides an oscillating impact grinding blade that is longer lasting and more reliable than those of the prior art.

Still another advantage of the present invention may be that it provides an oscillating impact grinding blade that lengthens the cutting edge of the blade via the use of a predetermined wave form pattern thereon.

Still another advantage of the present invention may be that it provides an oscillating impact grinding blade that removes masonry filler more efficiently because of the significantly wider swath of material removed in comparison to a prior art straight blade having an abrasive coating layer arranged thereon.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a plan view of a prior art oscillating blade.

FIG. 2 shows a partial cross section of the prior art oscillating blade of FIG. 1.

FIG. 3 shows a plan view of an oscillating blade according to an embodiment of the present invention.

FIG. 4 shows an edge view of an oscillating blade according to an embodiment of the present invention.

FIG. 5 shows an edge view of an alternative embodiment of an oscillating blade according to the present invention.

FIG. 6 shows an edge view of alternative embodiments of an oscillating blade according to the present invention.

FIG. 7 shows an edge view of an alternative embodiment of an oscillating blade according to the present invention.

FIG. 8 shows an edge view of an alternative embodiment of an oscillating blade according to the present invention.

FIG. 9 shows a plan view of an oscillating blade according to an alternate embodiment of the present invention.

### DESCRIPTION OF THE PREFERRED EMBODIMENT(S)

Referring to the drawings, the present invention of an oscillating blade 20 for use with an oscillating tool is shown. It should be noted that the oscillating blade 20 may use an abrasive grit structure that is selectively attachable to a tool or blade surface of a tool which uses the oscillating blade 20 or the like. Applicant has developed various methods and apparatuses for connecting and molding grits and/or teeth like structures to tools, blades or other surfaces, and the present invention may be used with any of the Applicant's previous inventions and therefore, the Applicant hereby incorporates by reference prior U.S. Pat. Nos. Re 35,812, 4,916,869 and 6,821,196.

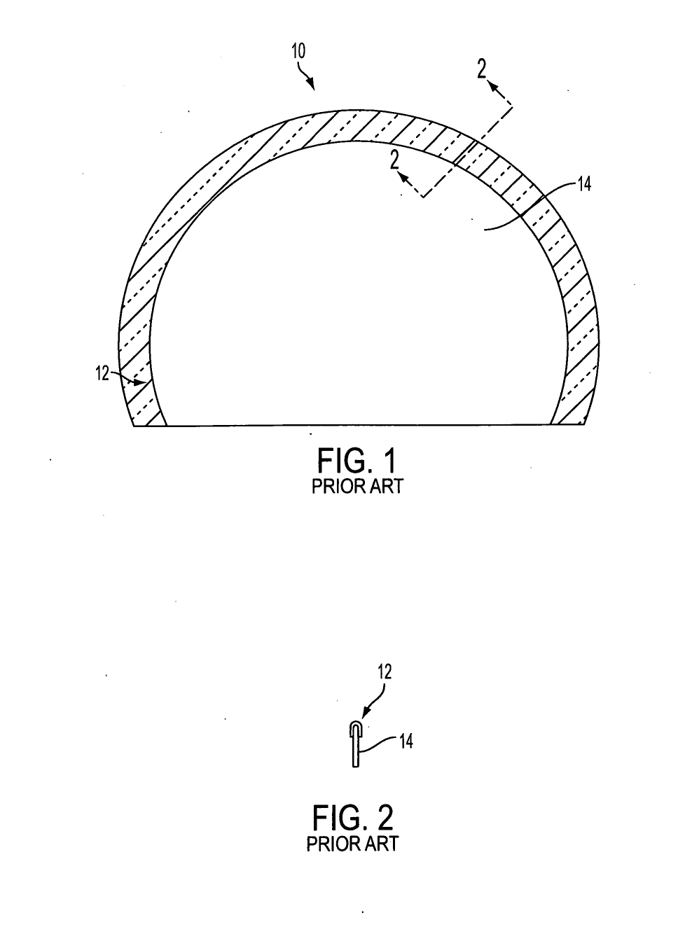

FIGS. 1 and 2 show a prior art oscillating blade 10 that may be used for removing grout. This prior art blade 10 generally has a thin circular body 14 that is typically made of a sheet steel and armed with abrasive grains 12 of tungsten carbide or diamond grit on an edge thereof. These typical prior art grout removal blades 10 for an oscillating multi tool were made generally from a semi circular thin steel disc of approximately one half millimeter to one and a half millimeter thickness. Abrasive grains 12 of tungsten carbide or diamond may be brazed bonded or nickel plated to the steel blank of the prior art blades 10 to a metal thickness circumference and to the surface a short distance down each side or face below the circumference. The prior art blades are then fitted to a multi tool and engaged into a grout line of seasoned grout, and the abrasive grains or grits 12 remove the grout by abrasive action. However, with many of these prior art oscillating blades 10 when removing masonry filler the process is much more like demolishing concrete with an impact device, such as a jackhammer. Hence, the material does not curl off in chips due to machining forces, it is removed by crushing the brittle cementitious bond that holds the aggregate together, returning the material to a condition much like it was originally before the blend of cement and aggregate was mixed with water and allowed to cure. Therefore, these prior art blades 10 generally have to be either wiggled or run several times through one joint in order to clear out a joint that is wider than the width of the blade 10 and associated abrasive grit particles 12.

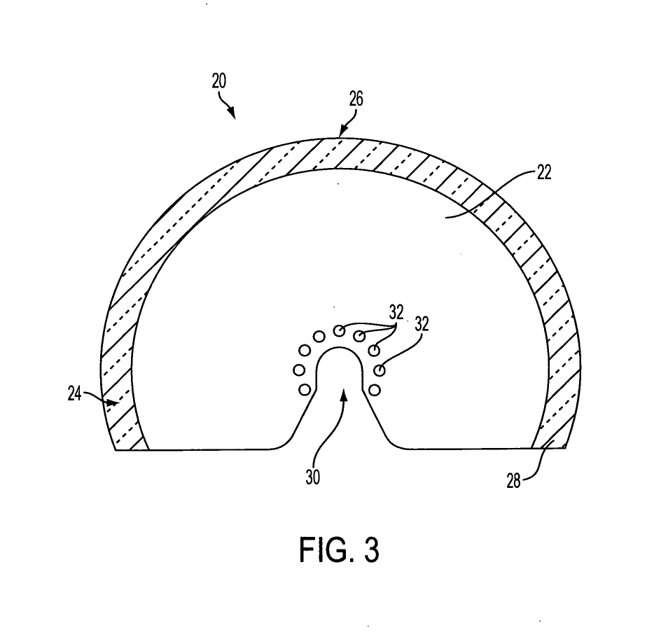

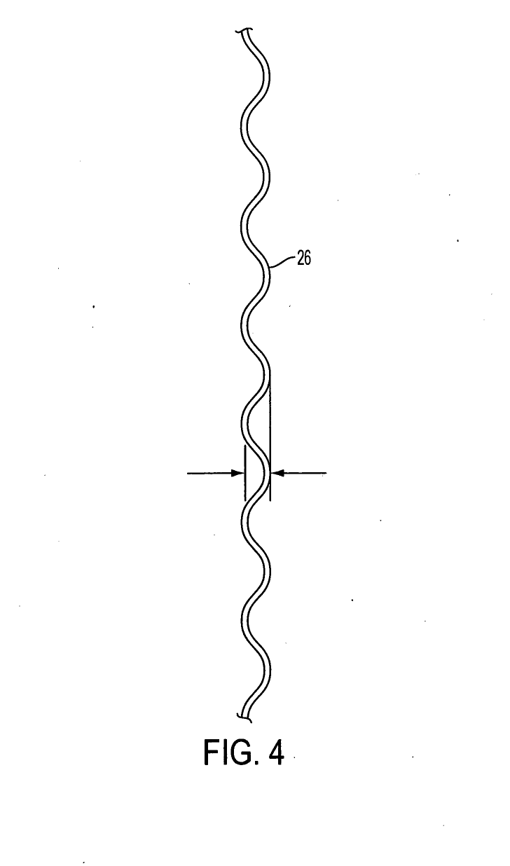

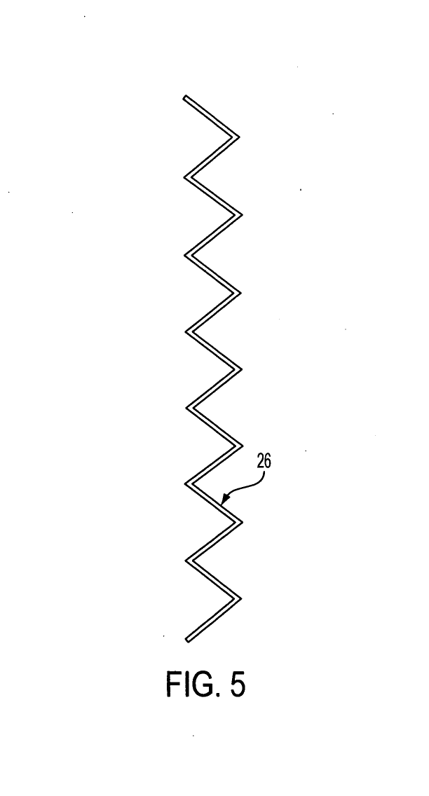

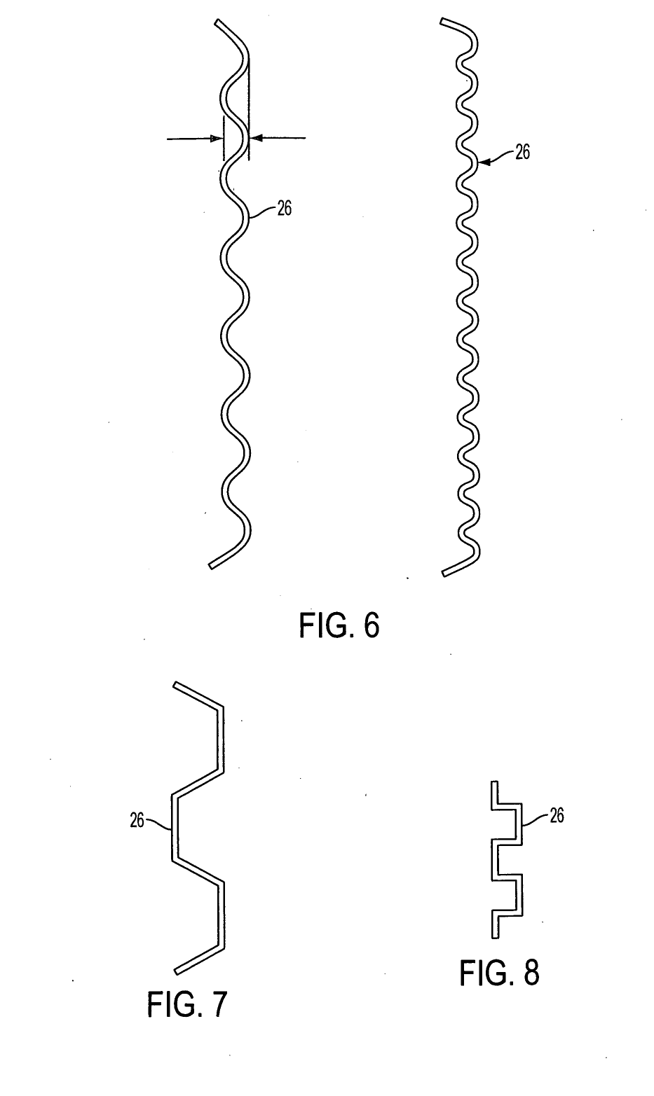

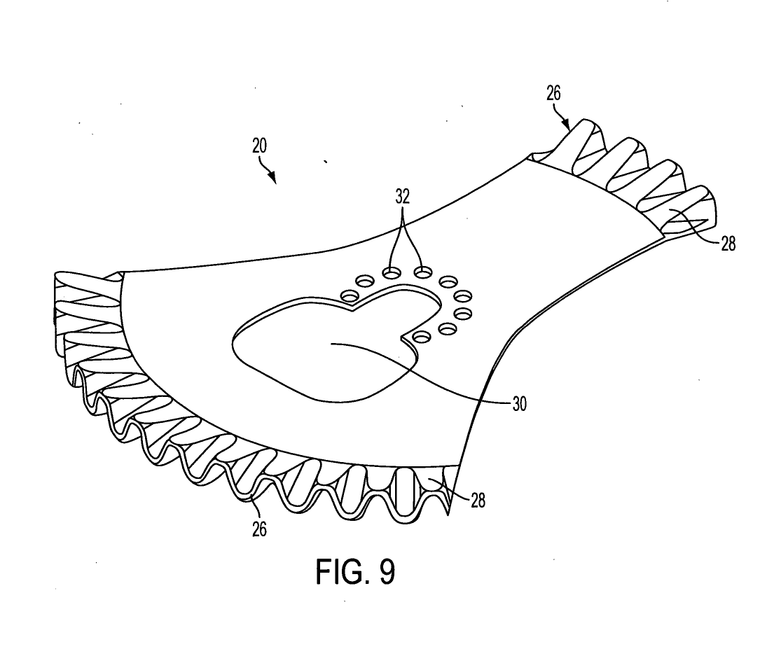

The new and improved oscillating blade 20 of the present invention is shown in FIGS. 3 through 8. As shown the oscillating blade 20 consists of an abrasive coated blade or accessory 20 for use in an oscillating multi tool for the purpose of removing masonry joint fillers, such as grout and mortar. The oscillating blade 20 of the present invention may utilize a unique base member or blank 22 design, which enables the oscillating blade 20, as designed, to clear away masonry filler material in a much faster time than those of the prior art and also to more effectively clear out joints that are significantly wider than the sum of the blank metal 22 thickness and the abrasive coating layer 24 together. The oscillating blade 20 of the present invention uses a steel blank or base member 22, which has been formed so as to have an axial pattern of a predetermined wave form 26 arranged laterally way from the central plane of the base member 22, along the cutting circumferential arc or edge 28, therefore appearing somewhat like a shape of a scallop shell when viewed on edge. It should be noted that the predetermined wave form of the present invention may have any known wave form 26 pattern, such as but not limited to, a sine wave, a “V” shaped wave, a “U” shaped wave, a square shaped wave, shark tooth wave, or any other known shape or random shape arranged thereon. The use of the blank or base member 22 of the present invention may enable the oscillating blade 20 to remove masonry filler in a reduced cost manner in a wider swath with a single pass through the joint. It should be noted that the predetermined wave form edge 26 may draw out the edge 28 of the oscillating blade 20 in either an axial or lateral direction to increase the swath or width of the removal or kerf of the blade 20 during operation on the joints. In one embodiment the natural kerf or rate of removal by the abrasive oscillating blade 20 of the present invention may be the sum of the metal thickness of the base member 22, plus the wave form 26 offset, plus the displacement of the abrasive coating layer 24 arranged over both sides of the cutting edge 28.

In one contemplated embodiment the oscillating blade 20 of the present invention may have two separate and distinct arc widths on its working cutting edge. This design may allow for the desirability of having two different geometries for a more effective clean out of both horizontal joints and vertical or end joints when removing mortar or grout from between bricks, titles, etc.

The oscillating blade 20 of the present invention may include a base member or blank 22. The base member or blank 22 generally may have any known shape. However, it should be noted that in one contemplated embodiment either a semi circular or circular blank of steel may be used to form the oscillating blade 20. It should be noted that steel is used in one contemplated embodiment, however any other metal, ceramic, composite, hard plastic, or natural material may also be used for the base member 22 of the oscillating blade 20. Generally, the base 22 may be laser cut, water jet cut or stamped into its predetermined shape, however any other known manufacturing technique or methodology may also be used to form the base 22. In one contemplated embodiment the shape may be a thin semi circular shape. It should be noted that any other known shape, such as circular, tomahawk like shape, a complete circle, a triangular shape, a tear drop shape, a square shape, or any other known shape may also be used for the oscillating blade 20 of the present invention. Generally, the width of the base member 22 may be within the range of 0.2 millimeters up to 4 millimeters, depending on the design requirements and the use of the oscillating blade 20. It should be noted that in one contemplated embodiment the thickness of the base member 22 of the oscillating blade 20 may be approximately 3 hundredths of an inch or approximately 0.7 millimeters. The base member 22 may include an attachment notch 30 arranged in one edge thereof. The attachment notch 30 may take any sort of shape, such as a nipple shape as shown in FIG. 3. The base member 22 may also include a plurality of orifices 32 through the thickness thereof. In one contemplated embodiment, the orifices 32 may generally be circular in shape and may be arranged in a circular pattern as shown in FIG. 3. It should be noted that the orifices 32 may have any known shape, not just circular, and may be arranged in any known pattern other than the circular or semi circular shape as shown in the drawings. It should also be noted that the attachment notch 30 may also be of any known shape other than that of a nipple as shown in FIG. 3. The base member 22 in another contemplated embodiment, may also include an attachment orifice arranged through a generally central portion or mid point of the base member 22 of the oscillating blade 20. The attachment orifice may have any known shape, such as a generally square like shape with an appendage extending from the top surface thereof or any other known shape needed to connect properly to an oscillating multi tool. A plurality of orifices 32 may also be arranged through the entire width of the base member 22 adjacent to the attachment orifice as described above in either a circular pattern or any other known pattern. It is also contemplated not to have the orifices 32 arranged through the body of the oscillating blade 20. It should further be noted that the base member may be of any known dimensions in length, width, diameter, thickness, etc. In one contemplated embodiment the width may be between the range of one inch to ten inches, depending on the design requirements and environment in which the oscillating blade 20 may be used.

The oscillating blade 20 of the present invention also may include a cutting edge 28 arranged around a predetermined portion of a circumferential edge of the base member 22. In one contemplated embodiment the cutting edge 28 is arranged along the entire circular portion of the outer peripheral circumferential edge of the base member 22 of the oscillating blade 20. The cutting edge 28 may have a predetermined width down the side from the edge of the oscillating blade 20. In one contemplated embodiment the cutting edge 28 is defined as the first one half inch outer peripheral edge extending down each side of the base member 22. Generally, the cutting edge 28 may be used to perform the removal of the grout or mortar from the joint between tiles or bricks. In one contemplated embodiment the cutting edge 28 may be encapsulated by an abrasive coating layer 24. The abrasive coating layer 24 may be attached to both sides and the outer end of the oscillating blade 20 surrounding and defining the cutting edge 28. The abrasive coating layer 24 generally may include a plurality of abrasive grains, such as but not limited to, tungsten carbide cobalt or diamond grits that may be applied via any known manufacturing methodology for securing such abrasive grains to a predetermined base layer. In contemplated embodiments such coating of abrasive grains may be accomplished via a brazing operation or a plating bonding operation, which are both well known in the prior art. It should be noted that both sides of the oscillating blade 20 and the outer peripheral end/edge in one contemplated embodiment may be encapsulated or covered with the abrasive grains in the form of the abrasive coating layer 24. It is also contemplated to have only certain portions of the cutting edge 28 encapsulated or covered with the abrasive coating layer 24 in the form of the abrasive grains. It should also be noted that the abrasive grains may coat more than just the cutting edge 28, but may extend further onto the base member 22 and in one contemplated embodiment, even completely cover the entire base member 22 in the abrasive grains.

It should also be noted that it is also contemplated to have the cutting edge 28 arranged on more than one outer edge or peripheral edge of the shape of the oscillating blade base member 22. In one contemplated embodiment the oscillating blade base member 22 may generally have the shape of a tomahawk head and a cutting edge 28 may be incorporated into one circumferential edge of the tomahawk and also a second cutting edge 28 may be incorporated into a second circumferential edge of the tomahawk shaped base member. Interspersed between the two cutting edges of the base member having the tomahawk shape, will be connecting edges or sides between the two cutting edges, the connecting edges do not have a cutting edge formed thereon. It should be noted that with any of the known shapes available for the base member 22, certain portions of the outer peripheral edge may be used and formed into a cutting edge 28, while certain other portions of that peripheral edge may not be used as a cutting edge 28 and may not have the cutting edge abrasive coating layer 24 attached thereto.

The oscillating blade 20 of the present invention also may include a predetermined shaped wave form 26 incorporated into or arranged along the cutting edge 28 of the oscillating blade 20. In one contemplated embodiment, the predetermined wave form 26 is arranged along the entire portion of the cutting edge 28 of the oscillating blade 20. The predetermined wave form 26 may have any known shape. In one contemplated embodiment the predetermined wave form 26 may be in the shape of a sine wave, a zigzag pattern, a “V” shaped wave, a “U” shaped wave, a square wave shape, or any other known random or known shape that is capable of being incorporated or formed into the outer cutting edge 28 of the oscillating blade 20. In one contemplated embodiment after the base member 22 is formed it may then be rolled between forming tools, such as but not limited to an opposing gear set, along the length of the circular or other shaped circumferential edge and radially inward a predetermined distance from the circumferential edge end or tapering back from the circumferential edge in order to generate the predetermined wave form 26 such as a sine wave or a zigzag pattern along the edge which forms the cutting edge 28. In another contemplated embodiment after the base member 22 is formed into its predetermined shape, a stamping tool or other tools may be used to shape via an impression the desired sine wave, zigzag pattern, or any other known wave form into the circumferential edge of the base member 22 during the forming process. This may be done via any known crimping methodology or any other known stamping methodology that may form the cutting edge 28 with a predetermined wave form 26 incorporated into or arranged on the outer peripheral edge of the oscillating blade 20. By using the abrasive coating layer 24 on the cutting edge 28 having a predetermined wave form 26 arranged or incorporated thereon may dramatically improve the material removal efficiency of the blade 20 by significantly altering the methodology by which the blade crushes and removes the cementitious joint filler material arranged between tiles, bricks, etc.

In one contemplated embodiment the wave form pattern 26 may increase the removal rate of material because in effect the length of the grit coated cutting edge 28 is increased such that more cutting is occurring at any one time. The wave form edge 26 has more length ready to accept the grit coating 24 that is applied thereto, thus increasing any work being done than that of the prior art circumference of a flat oscillating blade. The increase of available work surface with the grit coating 24 to the cutting edge 28 of the blade 20 may increase the removal rate because the particular angular swath or arc of contact with the material being removed by the cutting edge 28 of the blade 20 may be increased substantially. Furthermore, each width of the predetermined wave form 26 becomes a hammering surface thus the removal rate of material from the joint is greatly increased. Hence, when the oscillating tool oscillates the blade 20 at a predetermined oscillation speed, the blade 20, instead of being limited to the rotational hammering action of and resulting material removal rate determined by the size, shape and frequency of the grit particles themselves, may have the axial presentation of the wave form pattern 26 available to provide a much broader hammering surface for the oscillating blade 20. It should be noted that the wave form edge 26 of the base member 22 of the present invention may even remove masonry filler without any abrasive coating at all. However, an uncoated base member 22 without the abrasive coating 24 arranged thereon, may not be practical because of the longevity of the blade 20 would be greatly reduced. Hence, the combined action of the wave form 26 edges and the abrasive grains of the abrasive coating layer 24 may work in unison with each other to remove joint filler faster than either could do alone as either a straight blade or a wave form blade. Furthermore, the predetermined wave form edge 26 design of the oscillating blade 20 of the present invention may enhance and improve the material removal rate because the included angular gaps between succeeding wave form edges provides significant open spaces to help eject the material being removed from the cutting zone. The use of the waveform edge 26 also may reduce the weight of the blade 20 and overall oscillating tool, by reducing the thickness of the blade 20 necessary to remove wider kerfs.

It should further be noted that the wave form severity, i.e., the amplitude, frequency and phase, or depth of wave form profile and pitch, may be varied to greater or lesser depth and/or greater and/or lesser pitch between the wave form peaks or corners, thus providing for adjustment of both the kerf or cutting width and the aggressiveness with which the filler material may be removed. Furthermore, it must be noted that an oscillating multi tool may have a limited amount of stroke or oscillating angular displacement, such that the pitch of the wave form 26 profile may be optimized to the expected motion range of the power tool with which the oscillating blade 20 of the present invention may be used. In one example, a wave form pitch significantly greater from peak to peak from the angular reciprocating distance of the power tool may be expected to be less effective, or even severely counterproductive upon reaching some large value. Therefore, the combination of the predetermined wave form 26 arranged into the outer circumferential edge or a predetermined portion of the outer circumferential edge of an oscillating blade 20 and then having that wave form 26 coated with abrasive grains 24 results in a new and improved oscillating blade 20 for use in an oscillating multi tool, by removing grout and mortar more quickly and more efficiently than any known prior art oscillating blade.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A blade for an oscillating tool, said blade comprising:
a base;
a cutting edge arranged along a predetermined portion of a circumferential edge of said base;
an abrasive coating layer attached to said cutting edge; and
a predetermined wave form arranged along said cutting edge.

2. The blade of claim 1 wherein said base having a generally semi circular or generally tomahawk like shape.

3. The blade of claim 1 wherein said base having an attachment notch on an edge thereof.

4. The blade of claim 1 wherein said base having an attachment orifice therethrough.

5. The blade of claim 1 wherein said base having a plurality of orifices therethrough, said plurality of orifices arranged in a generally circular pattern.

6. The blade of claim 1 wherein said abrasive coating layer having grains therein, said abrasive coating layer applied to said cutting edge by brazing or plating bonding.

7. The blade of claim 6 wherein said grains are a tungsten carbide, cubic boron nitride, tungsten carbide cobalt or diamond material.

8. The blade of claim 1 wherein said wave form is a sine wave pattern.

9. The blade of claim 1 wherein said wave form is a zigzag pattern.

10. The blade of claim 1 wherein said wave form is a square pattern.

11. The blade of claim 1 wherein said base is made of steel.

12. The blade of claim 1 wherein said wave form increases a length of said cutting edge and a hammering surface of the blade.

13. The blade of claim 1 wherein said wave form increases a material removal rate for the blade by providing open spaces which assists in ejecting the material from a cutting zone.

14. An oscillating blade for use with an oscillating tool, said oscillating blade comprising:
a base having a predetermined shape and thickness;
a cutting edge located along a predetermined portion of a circumferential edge of said base;
an abrasive coating layer attached to and encapsulating said cutting edge; and
a predetermined wave form incorporated into said cutting edge.

15. The oscillating blade of claim 14 wherein said base having a generally semi circular shape or a generally tomahawk like shape.

16. The oscillating blade of claim 14 wherein said base having an attachment notch or attachment orifice.

17. The oscillating blade of claim 14 wherein said base having a plurality of orifices therethrough, said plurality of orifices arranged in a generally circular or semi circular pattern.

18. The oscillating blade of claim 14 wherein said coating layer is applied by brazing or plating bonding a tungsten carbide cobalt or diamond material to said cutting edge.

19. The oscillating blade of claim 14 wherein said wave form has a sine wave, zigzag pattern, square wave, “U” shaped wave, “V” shaped wave, or scallop shell like pattern.

20. A method of making an oscillating blade for use with an oscillating tool, said method comprising the steps of:
cutting a blank of material into a predetermined shape;
rolling or stamping a predetermined shaped wave form into a predetermined portion of a circumferential edge of said blank; and
coating said circumferential edge with abrasive grains via a brazing or plating bonding operation.
